(19) United States
(12) Patent Application Publication
(10) Pub. No.: US 2025/0196374 A1
(43) Pub. Date: Jun. 19, 2025

(54) PROTECTIVE SHEATH FOR INSERTING A MANIPULATOR ARM CONNECTED IN A SEALED MANNER TO AN EFFECTOR HOUSED IN THE CONFINED ENCLOSURE OF A GLOVEBOX, AND ASSOCIATED GLOVEBOX

(71) Applicants: COMMISSARIAT A L'ENERGIE ATOMIQUE ET AUX ENERGIES ALTERNATIVES, Paris (FR); Getinge Life Science France, Vendome (FR)

(72) Inventors: Coline NANTERMOZ, Gif-sur-Yvette Cedex (FR); Yann PERROT, Gif-sur-Yvette Cedex (FR); Nolwenn KAMMERER, Gif-sur-Yvette Cedex (FR); François MONNEROT, Saint Georges-sur-Cher (FR)

(73) Assignees: COMMISSARIAT A L'ENERGIE ATOMIQUE ET AUX ENERGIES ALTERNATIVES, Paris (FR); Getinge Life Science France, Vendome (FR)

(21) Appl. No.: 18/978,400

(22) Filed: Dec. 12, 2024

(30) Foreign Application Priority Data
Dec. 14, 2023 (FR) FR2314235

(51) Int. Cl. B25J 19/00; B25J 21/00; F16D 3/84

(52) U.S. Cl. CPC B25J 19/0083; B25J 21/005; F16D 3/845

(57) ABSTRACT

A protective sheath for inserting a manipulator arm into a glovebox, including a sealed coupling for removably fastening and connecting the manipulator arm, which is engaged in the protective sheath, to an effector, which is housed in the confined enclosure of a glovebox.

### TECHNICAL FIELD

The present invention relates to the field of gloveboxes, and more particularly to protective sheaths for the sealed insertion of an arm into a glovebox in order to manipulate elements contained in the confined enclosure of the glovebox.

### PRIOR ART

A glovebox is a hermetic enclosure, at least one of the walls of which is transparent, the hermetic enclosure being designed for manipulating substances and objects in a controlled atmosphere. Gloveboxes are particularly advantageous when the substances or objects to be manipulated are harmful to man or are contaminable, as is the case, for example, in the nuclear, chemical, pharmaceutical and medical sectors.

A glovebox comprises at least one through-opening formed in one of its walls and in which a flexible sleeve is intended to be mounted in a sealed manner, in order to access the products and materials present inside the glovebox. The flexible sleeve ensures that a controlled atmosphere is maintained within the enclosure by forming a hermetic barrier through which the elements contained in the enclosure can be manipulated.

Usually, the flexible sleeve is a glove for receiving an operator's hand. However, the manipulation of elements contained in a glovebox by means of a glove remains dangerous for an operator.

Specifically, there are risks of accidents that may break the sealing of the glovebox and therefore expose the operator to the harmful elements contained therein. In particular, there is the risk of the glove being pierced during a manipulation.

Although the glovebox is opaque to alpha and beta radiation, gamma radiation for its part may be transmitted through the glove. Thus, gloveboxes using a glove as flexible sleeve do not have optimum protection for the manipulation of radioactive elements by an operator.

Furthermore, certain tasks of manipulating elements contained in a glovebox by an operator are laborious, for example preventive maintenance and cleaning tasks. Carrying out these tasks by an operator reduces the available work time for other tasks having a higher added value.

In order to overcome at least some of the aforementioned disadvantages, a manipulator arm, for example a robotic arm or a slave arm of a remote manipulator, may be used for the manipulation of elements contained in a glovebox.

However, standard gloveboxes are not designed for installing a manipulator arm completely inside their enclosure. In particular, the interior of gloveboxes is generally cramped and may be cluttered with many objects. Moreover, a manipulator arm may not be suitable for withstanding the confined atmosphere of gloveboxes, which may in particular be corrosive, dust-laden and/or radioactive. Furthermore, the maintenance of manipulator arm arranged completely inside a glovebox would prove to be highly complex.

It is therefore preferable to arrange the manipulator arm outside the glovebox and to insert it into the flexible sleeve, which is where appropriate a protective sheath for protecting the manipulator arm, in order to manipulate the elements within the glovebox.

As with a glove, the protective sheath ensures that a controlled atmosphere is maintained within the glovebox by forming a hermetic barrier between the interior of the box and the manipulator arm. Furthermore, the protective sheath protects the manipulator arm against the confined atmosphere.

WO 2021/053598 A1 describes a protective sheath for inserting a robotic arm into a glovebox. The closed end of the protective sheath has a U shape for covering the effector of the robotic arm, in the form of a gripper, in the protective sheath. The protective sheath is therefore suitable only for the use of a gripper as effector of the robotic arm.

When manipulating an object contained in the confined enclosure of a glovebox, the protective sheath described by WO 2021/053598 A1 forms a wall between the effector and the element, which reduces the sensitivity and dexterity of the effector. In particular, the quality of the force feedback of the effector is diminished. Since the protective sheath is in direct contact with the elements contained there a in the glovebox, is considerable risk of tearing thereof and therefore of the confinement of the controlled atmosphere being broken. Similarly, the protective sheath may be deformed by the effector, for example pinched or marked, which risks it being pierced.

Furthermore, by completely covering the robotic arm and the effector, the protective sheath described by WO 2021/053598 A1 greatly impedes the freedom of movement of the robotic arm and of the effector. In particular, the protective sheath rotates simultaneously with the effector during a rotation of the latter about its longitudinal axis with respect to the rest of the robotic arm, this rotation being very useful for the screwing and unscrewing actions. This winding of the protective sheath further increases the risk of tearing.

EP 3 498 438 A1 describes a protective bellows for inserting a robotic arm into a glovebox, an effector in the form of a gripper being fastened at the end of the protective bellows to an actuating mechanism housed in the protective bellows. Thus, the robotic arm can engage in the protective bellows and be connected to the actuating mechanism so as to control the movements of the gripper in the glovebox.

However, the protective bellows described by EP 3 498 438 A1 has many disadvantages. In particular, this bellows is limited to a single effector which cannot be changed or replaced. Moreover, the effector fastened to the bellows is not free to rotate about its longitudinal axis, which prevents any screwing and unscrewing operation by the robotic arm. Furthermore, the bellows is not designed for large deflections of the robotic arm.

There is therefore a need to improve protective sheaths for the sealed insertion of a manipulator arm into a glovebox, in particular which overcomes the aforementioned disadvantages.

The object of the invention is to meet this or these needs at least in part.

### SUMMARY OF THE INVENTION

For this purpose, the invention relates to a protective sheath for inserting a manipulator arm into a glovebox, comprising:
a flexible and hermetic sleeve,
a support ring mounted in a sealed manner on an open end of the sleeve, the support ring being designed for fastening the sleeve to an enclosure ring of the glovebox in a sealed manner,
an end piece closing the end of the sleeve that is opposite the open end in a sealed manner, comprising:
   an end piece ring fixed with respect to the sleeve,
   a coupling fitted into the end piece ring and being infinitely rotatable about the central axis of the end piece ring, comprising an inner face, which is housed in the sleeve and configured to be removably fastened to the end of the manipulator arm, and an outer face, which is arranged outside the sleeve and configured to be removably fastened to an effector.

The term “manipulator arm” means an articulated mechanical arm for the manipulation of elements contained in a glovebox, the arm being controlled manually or in a computerized manner. In particular, the manipulator arm may be remotely operated, remotely controlled, programmed off-line and/or operated axis by axis via a human-machine interface. For example, the manipulator arm may be a robotic arm or a slave arm of a remote manipulator.

The term “effector” means a tool intended to be mounted at the end of a manipulator arm in order to allow it to carry out certain applications by interacting directly with an element contained in a glovebox. For example, the effector may be a grasping tool, in particular a gripper, or a portable electric tool.

Preferably, a portion of the sleeve at its open end is a bellows.

Preferably, the sleeve is translucent over at least part of its length, preferably over its whole length.

Preferably, the sleeve is made of polyurethane or polyvinyl chloride.

Preferably, the end piece comprises a rigid and transparent flange with an outer periphery fastened to the sleeve in a sealed manner and an inner periphery fastened to the end piece ring in a sealed manner.

Preferably, the sleeve comprises a frustoconical portion at its closed end, the end piece ring being fastened directly to the top of the frustoconical portion.

Preferably, the protective sheath comprises at least one rotary joint joining two portions of the sleeve to one another in a sealed manner, the two portions being infinitely rotatable with respect to one another about the longitudinal axis of the sleeve.

Preferably, the coupling comprises inner pins projecting from the inner face and being intended to be inserted into slots cut into a locking plate of the manipulator arm in order to fasten the manipulator arm to the coupling.

Preferably, the coupling comprises outer pins projecting from the outer face and being intended to be inserted into slots cut into a locking plate of the effector in order to fasten the effector to the coupling.

Preferably, the coupling comprises a connector extending from the inner face to the outer face in order to electrically connect the manipulator arm to the effector.

Preferably, the connector is an electronic board with tracks projecting from the inner face on the one hand and projecting from the outer face on the other hand.

Preferably, the end piece comprises a ball bearing arranged between the coupling and the end piece ring, surrounding the coupling coaxially.

The present invention also relates to an assembly for the manipulation of elements contained in a glovebox, comprising:
a protective sheath according to the present invention,
a manipulator arm configured to be engaged in the protective sheath while being removably fastened to the inner face of the coupling,
at least one effector configured to be removably fastened to the outer face of the coupling.

Preferably, the coupling comprises inner pins projecting from the inner face, the manipulator arm comprising a locking plate comprising slots each having an insertion part designed for inserting one of the inner pins and a fastening part in the continuation of the insertion part and being designed for fastening the manipulator arm to the coupling by translation of the inner pin from the insertion part, preferably the locking plate being designed to slide between a locking position, in which the inner pins are in the fastening part of the slots, and a disengagement position, in which the inner pins are in the insertion part of the slots.

Preferably, the coupling comprises outer pins projecting from the outer face, the effector comprising a locking plate comprising slots each having an insertion part designed for inserting one of the outer pins and a fastening part in the continuation of the insertion part and being designed for fastening the effector to the coupling by translation of the outer pin from the insertion part, preferably the locking plate being designed to slide between a locking position, in which the outer pins are in the fastening part of the slots, and a disengagement position, in which the outer pins are in the insertion part of the slots.

The present invention also relates to a glovebox comprising:
a hermetic enclosure comprising a through-opening formed in one of its walls, an enclosure ring being fastened to the edge of the opening,
an assembly according to the present invention, the protective sheath being fastened to the enclosure ring in a sealed manner, the effector being housed in the hermetic enclosure.

The present invention therefore essentially consists of a protective sheath comprising a sealed coupling for removably fastening and connecting a manipulator arm, which is engaged in the protective sheath, to an effector, which is housed in the confined enclosure of a glovebox.

The invention thus makes it possible to dispense with an envelope around the effector forming a wall between the elements to be manipulated and the effector. The sensitivity and the dexterity of the effector are then not diminished and the risks of tearing of the protective sheath and therefore of breaking the confinement of the hermetic enclosure are minimized.

Moreover, the protective sheath according to the invention allows easy connection between a manipulator arm and varied effectors while maintaining the sealing of the confined atmosphere. The same manipulator arm and the same protective sheath can thus be used for different applications requiring different effectors, without having to remove said manipulator arm and said protective sheath from the enclosure.

By virtue of the protective sheath according to the invention, the manipulator arm is neither immersed in nor brought into contact with the confined atmosphere of the glovebox. It is therefore protected from possible contamination and/or corrosion. The waste produced during a manipulation of elements contained in the glovebox is thus minimized, only the protective sheath and the effector being considered as disposable waste after manipulations. Furthermore, the protective sheath according to the invention consists of materials compatible with conventional waste treatment in the nuclear sector; it is in particular free of aluminium.

Moreover, the protective sheath allows maximum freedom of movements for the manipulator arm introduced within it. In particular, the protective sheath does not impede rotation of the effector about its longitudinal axis with respect to the manipulator arm, thereby greatly facilitating the screwing and unscrewing actions.

The protective sheath according to the invention is also suitable for already existing gloveboxes and therefore does not require any modification of the latter for fitting the protective sheath. In particular, the mounting of the sleeve and of the support ring in an enclosure ring may be similar to those already existing for the mounting of a glove in the opening of a glovebox. In particular, it may conform to the existing standards in accordance with standard ISO 11933-1.

The protective sheath according to the invention can be fitted to a glovebox in a simple and rapid manner. It is suitable for replacing a glove or another protective sheath without breaking the confinement of the controlled atmosphere.

### BRIEF DESCRIPTION OF THE DRAWINGS

Other advantages and features will become clearer upon reading the detailed description, which is illustrative and non-limiting, with reference to the following figures:

FIG. 1 is a schematic side view of a protective sheath according to the present invention.

FIGS. 2A and 2B are schematic side views of a protective sheath according to the present invention with a robotic arm engaged therein and connected to an effector in the form of a gripper.

FIG. 3 is a schematic side view of a glovebox according to the present invention.

FIG. 4 is a view in longitudinal section of an end piece of a protective sheath according to the invention.

FIG. 5 is a photograph of an end piece of a protective sheath according to the invention, taken from the outer face side of the coupling.

FIG. 6A is a view in longitudinal section of an end piece of a protective sheath according to the invention with a robotic arm and an effector which are connected to the coupling of the end piece, the locking plates of the robotic arm and of the effector being in the connecting locking position.

FIG. 6B is a view in longitudinal section of an end piece of a protective sheath according to the invention with a robotic arm and an effector which are connected to the coupling of the end piece, the locking plates of the robotic arm and of the effector being in a position allowing the disengagement of the inner and outer pins of the coupling.

FIG. 7 is a view in cross section of the connection between an effector and the end piece of a protective sheath according to the invention, the locking plate of the effector being in the connecting locking position.

FIG. 8 is a perspective view of an end piece of a protective sheath according to the invention connected to a robotic arm and an effector, the end piece, the robotic arm and the effector being sectioned longitudinally.

FIG. 9 is a schematic side view of a protective sheath according to the present invention with a robotic arm engaged therein, the protective sheath comprising a rotary joint.

FIG. 10 is a photograph of a protective sheath according to the present invention, the sleeve of the protective sheath comprising a frustoconical portion at its closed end, the end piece ring being fastened directly to the top of the frustoconical portion.

### DETAILED DESCRIPTION

For reasons of clarity, the various elements in the figures are not shown to scale, the actual dimensions of the various portions not necessarily being respected.

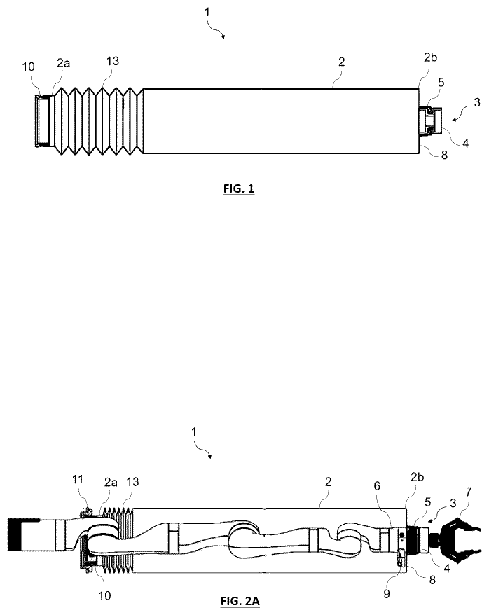

FIG. 1 illustrates a protective sheath 1 according to the present invention. The protective sheath 1 comprises a flexible and hermetic sleeve 2 which is open at its end 2a and closed at its other end 2b.

The flexibility of the sleeve 2 makes it possible for the movements of a manipulator arm not to be constrained. In particular, the sleeve 2 may be made of polyurethane or polyvinyl chloride. In addition to being flexible and hermetic, these materials have the advantage of having good resistance to tearing.

Preferably, the sleeve 2 is translucent. It is thus possible to observe the manipulator arm engaged in the sleeve 2, thereby making it easier for it to be controlled and manipulated. In particular, an operator is better aware of the articulated configuration of the manipulator arm during a remote operation.

An over-sheath may be fitted around the sleeve 2 in order to further reduce the risk of piercing or tearing of the sleeve 2.

The protective sheath 1 also comprises an end piece 3 that closes the end 2b of the sleeve 2 in a sealed manner. The end piece 3 comprises a coupling 4 fitted in a sealed manner into an end piece ring 5 while being able to rotate about the central axis of the end piece ring 5.

As is illustrated in FIGS. 2A and 2B, the coupling 4 is designed to mechanically and electrically connect the end of a robotic arm 6 engaged in the protective sheath 1 to an effector 7. The architecture and the operation of the coupling 4 will be explained later.

The robotic arm 6 may be a six- or seven-axis robot, for example a “Kinova Gen3” marketed by Kinova.

The end piece 3 also comprises a flange 8 whose outer periphery is fastened to the end 2b of the sleeve 2 in a sealed manner and whose inner periphery fastens the end piece ring 5 to the sleeve 2 in a sealed manner.

Preferably, the flange 8 is rigid and transparent. For example, the flange 8 is made of, in particular crystal, rigid polyvinyl chloride. Thus, the robotic arm 6 may comprise a camera module 9 at its end connected to the coupling 4 to observe the interior of the glovebox 12 through the flange 8.

Such a camera arrangement is preferable to the arrangements known from the prior art. For example, a camera fastened in the hermetic enclosure of a glovebox often has its field of view obstructed and is difficult to access for maintenance operations. A camera mounted outside the glovebox and observing the interior thereof through one of its transparent walls often has a poor point of view for following a manipulation operation.

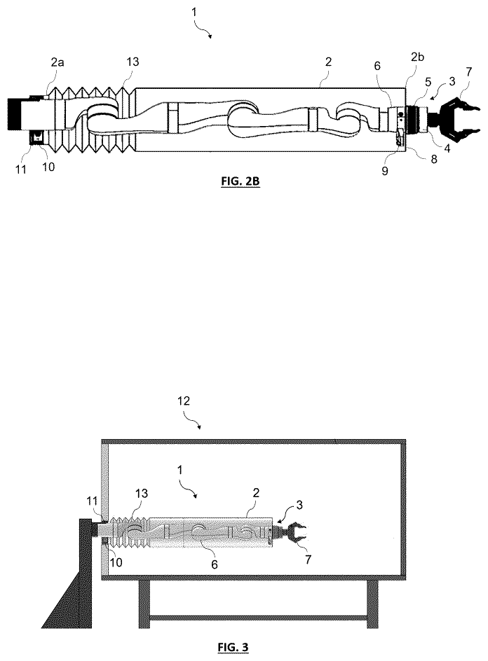

The protective sheath 1 also comprises a support ring 10 fastened to the open end 2a of the sleeve 2 in a sealed manner. As is illustrated in FIG. 3, the support ring 10 is designed to be fitted into an enclosure ring 11 of a glovebox 12 so that the sleeve 2 is fastened to the enclosure ring 11 in a sealed manner. The sealed mounting of the sleeve 2 with the enclosure ring 11 by virtue of the support ring 10 may conform to the existing standards in accordance with standard ISO 11933-1.

Thus, the protective sheath 1 is suitable for already existing gloveboxes 12 and therefore does not require any modification to the latter 12 in order to fit it in place. Moreover, the methods for fitting and replacing the protective sheath 1 are simple and similar to those which are already known from the prior art for the gloves of gloveboxes 12. They may be performed without breaking the confinement of the controlled atmosphere of the glovebox 12, in particular with the aid of an ejection gun.

The portion of the sleeve 2 at its open end 2a is, preferably, a bellows 13. As is illustrated in FIGS. 2A and 2B, the bellows 13 makes it possible, while deploying or retracting, to advance or retreat the robotic arm 6 in the glovebox 12 without risk of tearing of the sleeve 2. The robotic arm 6 may thus be driven into the glovebox 12 to a greater or lesser degree depending on the desired manipulation operation. Thus, for an operation in the glovebox 12 at a greater or lesser depth, that is to say at greater or lesser proximity to the wall, only certain axes of the robotic arm 6 may be inserted in a similar manner to an operator who either inserts only their hand and their wrist or inserts their arm up to the shoulder into a glovebox according the depth of the operations to be carried out.

Furthermore, the bellows 13 increases the freedom of movement of the robotic arm 6 engaged in the protective sheath 1. The bellows 13 also prevents the sleeve 2 from being too highly tensioned in the event of the latter being wound by the robotic arm 6 around its central axis.

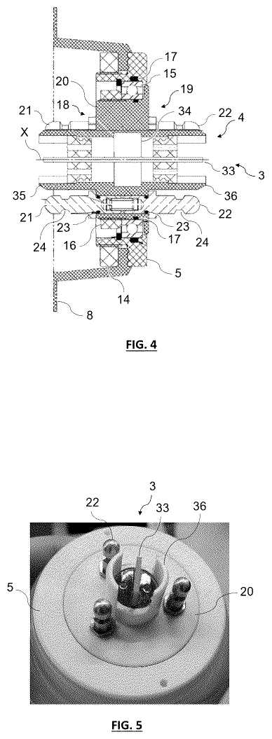

FIGS. 4 and 5 illustrate an end piece 3 of a protective sheath 1 according to the invention. The end piece 3 comprises the coupling 4 fitted in a sealed manner in the end piece ring 5, itself 5 fastened in a sealed manner to the flange 8. In particular, the end piece ring 5 is fastened on the flange 8 by clamping by means of a nut 14. Alternatively, the end piece ring 5 may be fastened directly on the sleeve 2 in a similar manner, or the sleeve 2 may comprise a bead housed with compression in the end piece ring 5.

The coupling 4 is infinitely rotatable with respect to the end piece ring 5 about its central axis X. In particular, the end piece 3 comprises a sealed ball bearing 15 arranged between the coupling 4 and the end piece ring 5. A ring 16 surrounds the coupling 4 to hold the ball bearing 5 in abutment. O-ring seals 17 ensure sealing between the coupling 4 and the ball bearing 15 and between the ball bearing 15 and the end piece ring 5.

The coupling 4 comprises an inner face 18 arranged in the sleeve 2 and an outer face 19 opposite the inner face 18 and outside of the sleeve 2. The coupling 4 comprises a tubular body 20 to which there are fastened inner pins 21, which project from the body 20 on the inner face 18 side, and outer pins 22, which project from the body 20 on the outer face 19 side. O-ring seals 23 ensure sealing of the fastening of the inner pins 21 and of the outer pins 22 to the body 20.

For example, the inner pins 21 and the outer pins 22 are distributed in a triangle. Each of the inner pins 21 and the outer pins 22 has the shape of a bowling pin, that is to say a cylindrical shape extending parallel to the central axis X and comprising a radial groove 24.

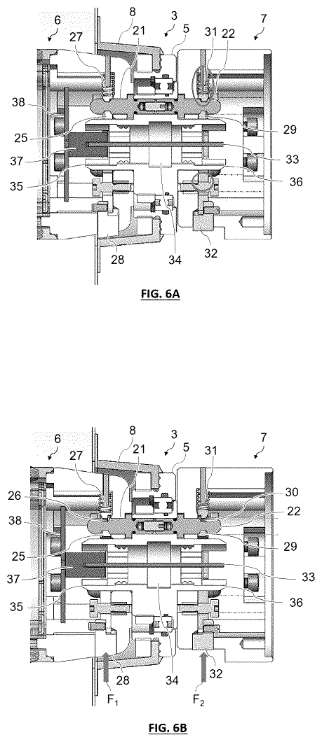

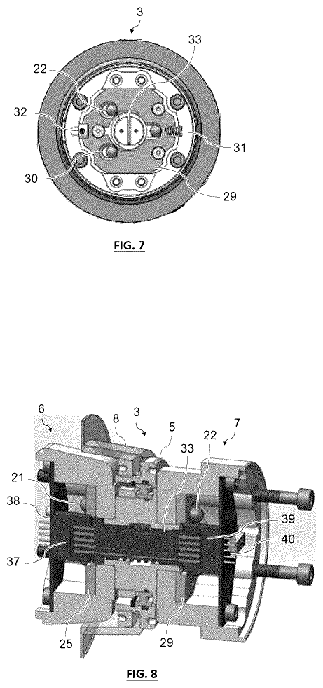

As illustrated in FIGS. 6A, 6B and 7, the inner pins 21 make it possible to removably fasten the end of the robotic arm 6 to the inner face 18 of the coupling 4, and the outer pins 22 make it possible to removably fasten the effector 7 to the outer face 19 of the coupling 4.

The robotic arm 6 comprises a locking plate 25 mounted slidably at its end. The locking plate 25 comprises through-slots 26. Each slot 26 comprises an insertion part having a wider cross section than that of the inner pins 21 and a fastening part in the continuation of the insertion part whose cross section has a shape complementary with the radial groove 24 in the inner pins 21.

Thus, the inner pins 21 can engage in the slots 26 through the insertion part and then the locking plate 25 can slide orthogonally to the central axis X such that the inner pins 21 translate in the slots 26 until they are inserted into the fastening part of the slots 26. Once in abutment in the fastening part of the slots 26, the inner pins 21 are blocked by the locking plate 25. The robotic arm 6 is then fastened to the coupling 4. FIG. 6A illustrates the locking plate 25 in its position of blocking the inner pins 21 in abutment in the fastening part of the slots 26.

The robotic arm 6 also comprises a helical spring 27 which, with a return force, holds the locking plate 25 in the locking position, that is to say with the inner pins 21 inserted in abutment into the fastening part of the slots 26. The helical spring 27 thus ensures the blocking of the inner pins 21 by the locking plate 25.

The unblocking of the inner pins 21 is achieved by sliding the locking plate 25 orthogonally to the central axis X, which compresses the helical spring 27, with the result that the inner pins 21 translate in the slots 26 until they are inserted into the insertion part of the slots 26. The inner pins 21 can then be disengaged from the slots 26. The robotic arm 6 is then no longer fastened to the coupling 4.

The sliding movement of the locking plate 25 may be actuated by means of a pushbutton 28. The pushbutton 28 may be arranged facing the helical spring 27.

FIG. 6B illustrates the locking plate 25 in its position of compressing the helical spring 27 with the inner pins 21 in the insertion part of the slots 26. The arrow F₁ symbolizes the pushing force applied to the pushbutton 28 to cause the locking plate 25 to slide.

Similarly, the effector 7 comprises a locking plate 29 mounted slidably at one of its ends. The locking plate 29 comprises through-slots 30. Each slot 30 comprises an insertion part having a wider cross section than that of the outer pins 22 and a fastening part in the continuation of the insertion part whose cross section has a shape complementary with the radial groove 24 in the outer pins 22.

Thus, the outer pins 22 can engage in the slots 30 through the insertion part and then the locking plate 29 can slide orthogonally to the central axis X such that the outer pins 22 translate in the slots 30 until they are inserted into the fastening part of the slots 30. Once in abutment in the fastening part of the slots 30, the outer pins 22 are blocked by the locking plate 29. The effector 7 is then fastened to the coupling 4. FIGS. 6A and 7 illustrate the locking plate 29 in its position of blocking the outer pins 22 in abutment in the fastening part of the slots 30.

The effector 7 also comprises a helical spring 31 which, with a return force, holds the locking plate 29 in the locking position, that is to say with the outer pins 22 inserted in abutment into the fastening part of the slots 30. The helical spring 31 thus ensures the blocking of the outer pins 22 by the locking plate 29.

The unblocking of the outer pins 22 is achieved by sliding the locking plate 29 orthogonally to the central axis X, which compresses the spring 31, with the result that the outer pins 22 translate in the slots 30 until they are inserted into the insertion part of the slots 30. The outer pins 22 can then be disengaged from the slots 30. The effector 7 is then no longer fastened to the coupling 4.

The sliding movement of the locking plate 29 may be actuated by means of a pushbutton 32. The pushbutton 32 may be arranged facing the helical spring 31.

FIG. 6B illustrates the locking plate 29 in its position of compressing the helical spring 31 with the outer pins 22 in the insertion part of the slots 30. The arrow F₂ symbolizes the pushing force applied to the pushbutton 32 to cause the locking plate 29 to slide.

The glovebox 12 may also comprise an effector-carrier station on which a plurality of different effectors may be deposited and in order to facilitate the assembly of an effector 7 with the coupling 4.

As is illustrated in FIGS. 4 to 7, the coupling 4 also comprises a connector 33 housed in the through-opening of the tubular body 20 and extending from the inner face 18 to the outer face 19. The connector 33 is secured to the body 20.

The connector 33 illustrated in FIGS. 4 to 7 is an electronic board. Alternatively, any type of sealed connector suitable for transmitting electrical power and data by electrical signals is conceivable for the connector 33, for example, the connector 33 may be a sealed connector marketed by Souriau.

A seal 34 provides sealing between the connector 33 and the tubular body 20, the through-opening in the tubular body 20 thus being closed in a sealed manner. The seal 34 may be formed by pouring silicone into the space between the connector 33 and the body 20.

The body 20 comprises an inner guide portion 35 and an outer guide portion 36 extending at the periphery of the connector 33 so as to project from the inner face 18 and the outer face 19, respectively. The inner 35 and outer 36 guide portions are in the form of a split sleeve.

The connector 33 is configured to transmit electrical signals between the robotic arm 6 and the effector 7. FIG. 8: illustrates the robotic arm 6 connected electrically to the effector 7 via the connector 33.

The robotic arm 6 is connected to the coupling 4 and comprises a female plug 37 into which the connector 33 is plugged. In the embodiment illustrated in FIG. 8, the plug 37 is welded to an electronic board 38 of the robotic arm 6.

Similarly, the effector 7 is connected to the coupling 4 and comprises a female plug 39 into which the connector 33 is plugged. In the embodiment illustrated in FIG. 8, the plug 39 is welded to an electronic board 40 of the effector 7.

Thus, once the robotic arm 6 and the effector 7 are connected to the end piece 3, they 6, 7 are electrically connected together and the robotic arm 6 can control the effector 7.

The inner guide portion 35 and the outer guide portion 36 mechanically protect the connector 33 during the connection of the robotic arm 6 and of the effector 7, respectively, to the coupling 4 while guiding the plug 37 and the plug 39, respectively.

In the embodiment illustrated in FIG. 8, it is the connector 33 which is plugged into the female plugs 37 and 38. Alternatively, the plugs 37 and/or 38 may be male plugs which are plugged into the connector 33.

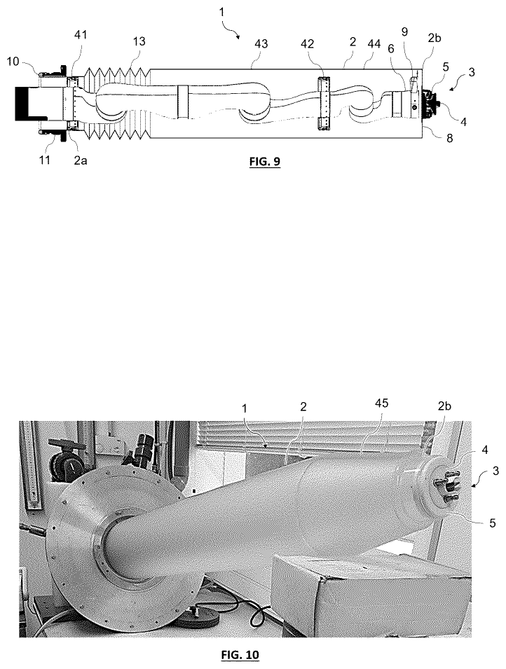

FIG. 9 illustrates another embodiment of a protective sheath 1 according to the present invention. The protective sheath 1 illustrated in FIG. 9 differs from that illustrated in FIGS. 2A and 2B in that it comprises first 41 and second 42 rotary joints. The first rotary joint 41 is mounted on the sleeve 2 at its end 2a. The second rotary joint 42 is mounted on the sleeve 2, dividing the latter into a proximal portion 43, extending from the first rotary joint 41 to the second rotary joint 42, and a distal portion 44, extending from the second rotary joint 42 to the closed end 2b.

The first rotary joint 41 joins the end 2a of the sleeve 2 to the proximal portion 43 in a sealed manner while allowing infinite rotation, around the longitudinal axis of the sleeve 2, of the proximal portion 43 with respect to the end 2a of the sleeve 2.

The second rotary joint 42 joins the proximal portion 43 to the distal portion 44 in a sealed manner while allowing infinite rotation, about the longitudinal axis of the sleeve 2, of the distal portion 44 with respect to the proximal portion 43.

Advantageously, the first 41 and second 42 rotary joints increase the freedom of movement of the robotic arm 6 engaged in the protective sheath 1. In particular, the first 41 and second 42 rotary joints prevent the sleeve 2 from winding on itself during a rotation of the robotic arm 6.

FIG. 10 illustrates another embodiment of a protective sheath 1 according to the present invention. The protective sheath 1 illustrated in FIG. 10 differs from that illustrated in FIGS. 2A and 2B in that it does not have a flange 8 and does not have a bellows 13. The absence of the flange 8 and the bellows 13 simplifies the manufacture of a protective sheath 1 according to the invention and facilitates the insertion of said protective sheath 1 into a glovebox 12. The absence of the bellows 13 also reduces the risk of a potential accumulation of contamination on the sleeve 2.

The sleeve 2, illustrated in FIG. 10, comprises a frustoconical portion 45 at its closed end 2b. The end piece ring 5 is fastened directly to the top of the frustoconical portion 45, for example by clamping as described above for FIG. 4.

Other variants and improvements may be envisaged without departing from the scope of the invention. For example, it is conceivable that the coupling 4 comprises an inner locking plate, in place of the inner pins 21, designed for fastening a manipulator arm comprising projecting pins, and/or an outer locking plate, in place of the outer pins 22, designed for fastening an effector comprising projecting pins, the operation of the inner and outer locking plates being similar to the operation of the locking plates 25 and 29.

1. A protective sheath for inserting a manipulator arm into a glovebox, comprising:
a flexible and hermetic sleeve,
a support ring mounted in a sealed manner on an open end of the sleeve, the support ring being designed for fastening the sleeve to an enclosure ring of the glovebox in a sealed manner,
an end piece closing the end of the sleeve that is opposite the open end in a sealed manner, comprising:
an end piece ring fixed with respect to the sleeve,
a coupling fitted into the end piece ring and being infinitely rotatable about the central axis of the end piece ring, comprising an inner face, which is housed in the sleeve and configured to be removably fastened to the end of the manipulator arm, and an outer face, which is arranged outside the sleeve and configured to be removably fastened to an effector.

2. The protective sheath according to claim 1, a portion of the sleeve at its open end being a bellows.

3. The protective sheath according to claim 1, the sleeve being translucent over at least part of its length, preferably over its whole length.

4. The protective sheath according to claim 1, the sleeve being made of polyurethane or polyvinyl chloride.

5. The protective sheath according to claim 1, the end piece comprising a rigid and transparent flange with an outer periphery fastened to the sleeve in a sealed manner and an inner periphery fastened to the end piece ring in a sealed manner.

6. The protective sheath according to claim 1, the sleeve comprising a frustoconical portion at its closed end, the end piece ring being fastened directly to the top of the frustoconical portion.

7. The protective sheath according to claim 1, comprising at least one rotary joint joining two portions of the sleeve to one another in a sealed manner, the two portions being infinitely rotatable with respect to one another about the longitudinal axis of the sleeve.

8. The protective sheath according to claim 1, the coupling comprising inner pins projecting from the inner face and being intended to be inserted into slots cut into a locking plate of the manipulator arm in order to fasten the manipulator arm to the coupling.

9. The protective sheath according to claim 1, the coupling comprising outer pins projecting from the outer face and being intended to be inserted into slots cut into a locking plate of the effector in order to fasten the effector to the coupling.

10. The protective sheath according to claim 1, the coupling comprising a connector extending from the inner face to the outer face in order to electrically connect the manipulator arm to the effector.

11. The protective sheath according to claim 10, the connector being an electronic board with tracks projecting from the inner face on the one hand and projecting from the outer face on the other hand.

12. The protective sheath according to claim 1, the end piece comprising a ball bearing arranged between the coupling and the end piece ring, surrounding the coupling coaxially.

13. An assembly for the manipulation of elements contained in a glovebox, comprising
protective sheath according to claim 1,
a manipulator arm configured to be engaged in the protective sheath while being removably fastened to the inner face of the coupling,
at least one effector configured to be removably fastened to the outer face of the coupling.

14. The assembly according to claim 13, the coupling comprising inner pins projecting from the inner face, the manipulator arm comprising a locking plate comprising slots each having an insertion part designed for inserting one of the inner pins and a fastening part in the continuation of the insertion part and being designed for fastening the manipulator arm to the coupling by translation of the inner pin from the insertion part, preferably the locking plate being designed to slide between a locking position, in which the inner pins are in the fastening part of the slots, and a disengagement position, in which the inner pins are in the insertion part of the slots.

15. The assembly according to claim 13, the coupling comprising outer pins projecting from the outer face, the effector comprising a locking plate comprising slots each having an insertion part designed for inserting one of the outer pins and a fastening part in the continuation of the insertion part and being designed for fastening the effector to the coupling by translation of the outer pin from the insertion part, preferably the locking plate being designed to slide between a locking position, in which the outer pins are in the fastening part of the slots, and a disengagement position, in which the outer pins are in the insertion part of the slots.

16. A glovebox comprising:
a hermetic enclosure comprising a through-opening formed in one of its walls, an enclosure ring being fastened to the edge of the opening, and
an assembly according to claim 13, the protective sheath being fastened to the enclosure ring in a sealed manner, the effector being housed in the hermetic enclosure.
